(19) United States
(12) Patent Application Publication
(10) Pub. No.: US 2026/0298321 A1
(43) Pub. Date: Oct. 1, 2026

(54) RECIPROCATING MECHANICAL DEVICES AND METHODS OF OPERATION

(71) Applicant: William Gardetto, Colleyville, TX (US)

(72) Inventor: William Gardetto, Colleyville, TX (US)

(21) Appl. No.: 19/097,561

(22) Filed: Apr. 1, 2025

(51) Int. Cl. F16H 37/12; F01B 29/08; F02B 75/18; F02B 75/32; F04B 35/01

(52) U.S. Cl. CPC F16H 37/124; F01B 29/08; F02B 75/18; F02B 75/32; F04B 35/01

(57) ABSTRACT

Reciprocating mechanical devices and methods of their operation. Such a reciprocating mechanical device includes a cylinder bore, a piston disposed in the cylinder bore for reciprocation therein, and a connecting rod that pivotably couples the piston to a crank at respective first and second ends thereof. The crank rotates in a plane disposed at an inclination angle to an axis of the cylinder bore. The crank has a hub, an arm radially extending from the hub, and a coupling on the arm to pivotably couple the arm to the second end of the connecting rod. The inclination angle of the crank causes the connecting rod to have a three-dimensional motion and causes the coupling between the connecting rod and the crank to travel on an elliptical rotational path relative to the axis of the first cylinder bore.

### BACKGROUND OF THE INVENTION

The present invention generally relates to reciprocating mechanical devices, including motors (e.g., internal combustion engines) and compressors, that utilize one or more reciprocating pistons. More particularly, the invention relates to reciprocating mechanical devices capable of operating with improved efficiencies and power during a stroke of a piston thereof.

Traditional internal combustion engines and certain types of pumps and compressors are nonlimiting examples of reciprocating mechanical devices that operate through the action of one or more pistons, each of which is connected to a crankshaft and reciprocates within a cylinder bore (sometimes simply referred to as a cylinder for convenience). In traditional internal combustion engines of the types used in vehicles (as used herein, including aircraft, automobiles, boats, etc.), the crankshaft converts linear motion of the pistons within their cylinders into rotational motion, which is typically output to a drive shaft. In the case of a pump or compressor utilizing one or more pistons, the crankshaft is rotated by a motor or other suitable device and its rotational motion is converted to the linear motions of the pistons within their cylinders, for example, to pump a liquid or a gas, compress air or another gas, etc. In either case, the traditional arrangement by which a piston is connected to the crankshaft results in the motion of the piston and its connecting rod lying entirely within a single plane, i.e., two-dimensional, such that the connection between the crankshaft and connecting rod follows a two-dimensional circular path around the axis of the crankshaft in the same plane as the motion of the piston.

The position of a piston farthest from the crankshaft is known as top-dead-center (TDC), and the position of a piston when closest to the crankshaft is known as bottom-dead-center (BDC). A characteristic common to the TDC position of a piston is that a force applied to the piston (e.g., as a result of combustion within the cylinder of a traditional internal combustion engine) is through the axis of the connecting rod that connects the piston to the crankshaft, with the result that no torque can be transmitted from the piston to the crankshaft at TDC. To compensate, reciprocating mechanical devices that operate through the action of pistons commonly utilize energy stored in a flywheel to overcome the loss of torque at TDC of its pistons, and/or utilize multiple pistons so that the top-dead-centers of all pistons do not occur at the same time.

Though the above-noted measures are effective to some degree, it is an ongoing desire to enhance the performance and optimize reciprocating mechanical devices, for example, by increasing their efficiency and power. Such improvements are particularly desirable if also capable of reducing the emissions and related carbon footprints of an internal combustion engine.

### BRIEF SUMMARY OF THE INVENTION

The intent of this section of the specification is to briefly indicate the nature and substance of the invention, as opposed to an exhaustive statement of all subject matter and aspects of the invention. Therefore, while this section is intended to be directed to and consistent with subject matter recited in the claims, additional subject matter and aspects relating to the invention are set forth in other sections of the specification, particularly the detailed description, as well as any drawings.

The present invention provides, but is not limited to, reciprocating mechanical devices and methods of their operation.

According to a nonlimiting aspect of the invention, a reciprocating mechanical device is provided that includes at least a first cylinder bore having an axis, a first piston disposed in the first cylinder bore and adapted for reciprocation therein between a top-dead-center position and a bottom-dead-center position of the first piston, a first connecting rod having a first end pivotably coupled with the first piston, and a first crank having an axis about which the first crank is adapted to rotate in a plane disposed at an inclination angle to the axis of the first cylinder bore. The inclination angle is greater than 0 degrees and up to 45 degrees. The first connecting rod protrudes from the first cylinder bore and has a second end disposed outside of the first cylinder bore. The first crank has a hub, an arm radially extending from the hub, and a coupling on the arm a radial distance from the axis. The coupling pivotably couples the arm to the second end of the first connecting rod. The inclination angle of the first crank causes the connecting rod to have a three-dimensional motion and causes the coupling between the connecting rod and the crank to travel on an elliptical rotational path relative to the axis of the first cylinder bore.

Technical effects of reciprocating mechanical devices and methods as described above include the capability of improved power and efficiency by replacing the two-dimensional motion of a connecting rod in a traditional piston-to-crankshaft arrangement with a three-dimensional motion in which the connection between the connecting rod and the crank travels on an elliptical rotational path. This additional dimension is preferably capable of more effectively harnessing a change in displaced movement of the piston and increasing the torque output of the piston.

Other aspects and advantages will be appreciated from the following detailed description as well as any drawings.

### BRIEF DESCRIPTION OF THE SEVERAL VIEWS OF THE DRAWING

FIG. 1 is a schematic end view of a reciprocating mechanical device comprising a piston disposed in a cylinder bore for reciprocation therein, a crank disposed at an inclination angle α to an axis of the cylinder bore, and a connecting rod that connects the piston to the crank in accordance with nonlimiting aspects of the present invention.

FIG. 2A is a perspective view of a reciprocating mechanical device, such as of the type represented in FIG. 1, showing internal components of the device including pistons disposed in corresponding cylinder bores for reciprocation therein, a crank disposed at an inclination angle α to an axis of each cylinder bore, and a connecting rod that connects a corresponding one of the pistons to a corresponding one of the cranks in accordance with nonlimiting aspects of the present invention, wherein the pistons are depicted at different locations within their respective cylinder bores corresponding to different points of ignition cycles thereof.

FIGS. 2B and 2C depict, respectively, side and end views of the reciprocating mechanical device represented in FIG. 2A, wherein only certain components of the device of shown for purposes of illustration.

FIG. 2D represents an exploded view of the reciprocating mechanical device represented in FIG. 2A, wherein only certain components of the device of shown for purposes of illustration.

FIG. 3 represents an isolated view of a cylinder, piston, connecting rod, and crank as viewed from one end of the reciprocating mechanical device as represented in FIG. 2C. For purposes of illustration, the crank is shown as disposed at an inclination angle α of about 37 degrees to the axis of the cylinder bore.

FIGS. 4A, 4B, and 4C represent isolated views of the cylinder, piston, connecting rod, and crank of FIG. 3 and show, respectively, the piston at top-dead-center (TDC), mid-stroke, and bottom-dead-center (BDC) positions within the cylinder bore and resulting positions of the connecting rod and crank.

FIG. 5 represents the mid-stroke position of the piston as shown in FIG. 4B, and includes representations of the location of the connecting rod relative to the axis of the cylinder bore taken from three different views, two of which evidencing that the connecting rod follows an elliptical rotational path relative to the axis of the cylinder bore when the crank is disposed at an inclination angle α to the axis of the cylinder bore.

FIG. 6A represents the mid-stroke position of the piston as shown in FIG. 5 and representations of the location of the connecting rod relative to the axis of the cylinder bore taken from the two views in FIG. 5 that evidence the elliptical rotational path of the connecting rod relative to the axis of the cylinder bore when the crank is disposed at an inclination angle α to the axis of the cylinder bore, and FIG. 6B represents the mid-stroke position of a piston similar to what is shown in FIG. 6A but with the crank disposed at an inclination angle α of 0 degrees to the axis of the cylinder bore and evidencing that the connecting rod does not follow an elliptical rotational path relative to the axis of the cylinder bore.

FIG. 7 is a schematic representation of the elliptical rotational path represented in FIGS. 5 and 6A.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) depicted in the drawings. The following detailed description also describes certain investigations relating to the embodiment(s) depicted in the drawings, and identifies certain but not all alternatives of the embodiment(s) depicted in the drawings. As nonlimiting examples, the invention encompasses additional or alternative embodiments in which one or more features or aspects shown and/or described as part of a particular embodiment could be eliminated. Therefore, the appended claims, and not the detailed description, are intended to particularly point out subject matter regarded to be aspects of the invention, including certain but not necessarily all of the aspects and alternatives described in the detailed description.

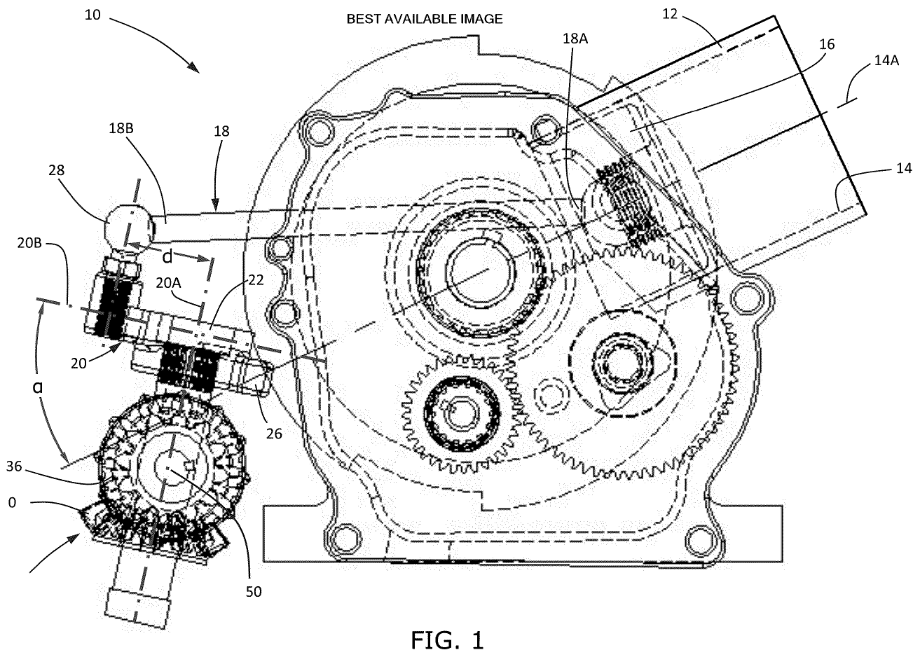

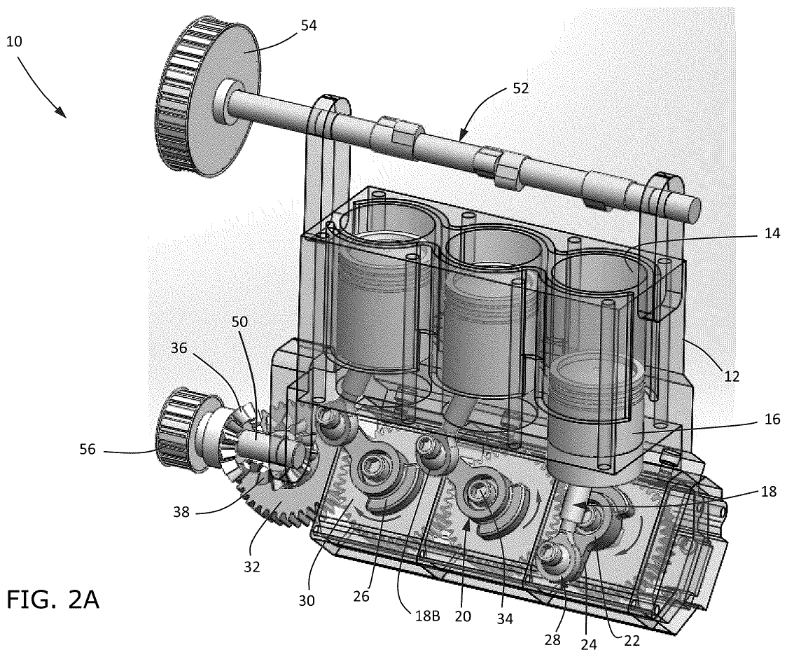

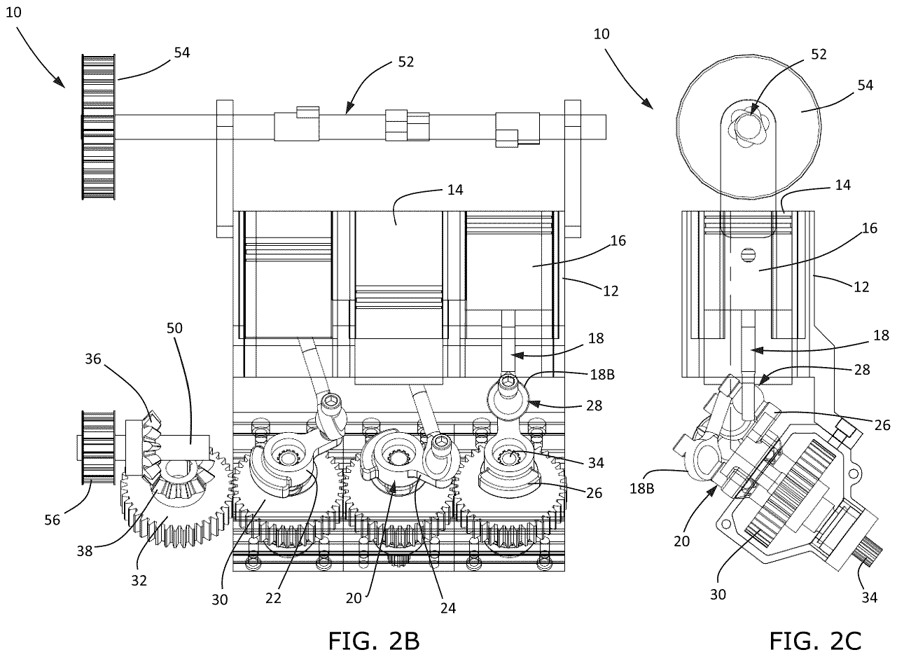

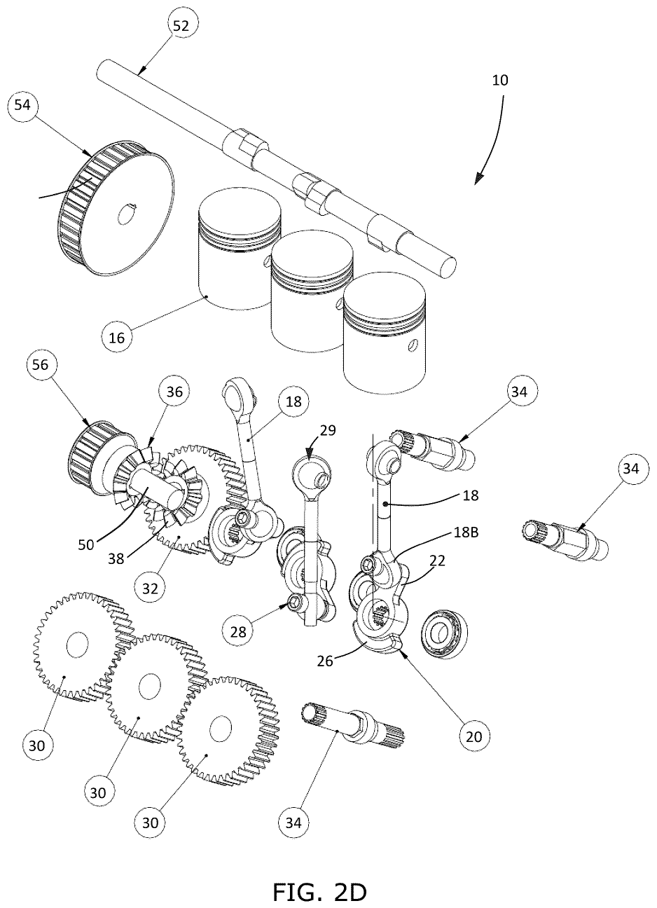

FIGS. 1 through 7 schematically represent embodiments and certain aspects of reciprocating mechanical devices 10 adapted for converting between the linear motion of one or more pistons 16 and the rotational motion of a shaft 50. For example, if the devices 10 are operating as a motor such as an internal combustion engine, the linear motion(s) of the piston(s) 16 are converted into rotational motion of the shaft 50 (such that it operates as an output shaft), and if the devices 10 are operating as a pump or compressor the shaft 50 is rotated by an external power source, such as a motor, and its rotational motion is converted to the linear motion of the piston(s) 16 (such that the shaft 50 operates as an input shaft). Though the arrangements represented in FIGS. 1 through 7 are capable of both of these modes of operation, the following discussion will focus primarily on the operation of the devices 10 as internal combustion engines. FIG. 1 schematically represents an embodiment of the reciprocating mechanical device 10 in which a single piston 16 is shown, and FIGS. 2A through 2C schematically represent an embodiment of the reciprocating mechanical device 10 in which three pistons 16 thereof are shown at various different locations within their respective cylinder bores 14 corresponding to different points of ignition cycles. FIG. 2D represents an exploded view of the device 10 shown in FIGS. 2A through 2C. For convenience, consistent reference numbers are used throughout drawings to identify the same or functionally related/equivalent elements of the embodiments of the reciprocating mechanical devices 10 represented in the drawings.

To facilitate the description provided below of the reciprocating mechanical devices 10, relative terms, including but not limited to, “proximal,” “distal,” “vertical,” “horizontal,” “lateral,” “front,” “rear,” “side,” “forward,” “rearward,” “top,” “bottom,” “upper,” “lower,” “above,” “below,” “right,” “left,” etc., are useful to describe the reciprocating mechanical devices 10 and components thereof as represented in FIGS. 1 through 7, but should not be interpreted as limitations to the construction, installation, operation, and use of the devices 10.

An embodiment of the reciprocating mechanical device 10 will first be described in reference to FIG. 1, in which the reciprocating mechanical device 10 is as comprising a cylinder bore 14 that is disposed within a cylinder block 12 and defines an axis 14A, and a piston 16 is shown as disposed in the cylinder bore 14 and adapted for reciprocation therein. As such, the piston 16 has an axis (unlabeled) that substantially coincides with the axis 14A of the bore 14. Though a single bore 14 and piston 16 are visible in FIG. 1, it should be understood that the device 10 could be equipped with additional pistons and their corresponding bores (e.g., FIGS. 2A through 2D), and such bores and pistons could be inline with the bore 14 and piston 16 shown in FIG. 1, or directly oppose the bore 14 and piston 16, or be arranged in a V-configuration with the bore 14 and piston 16.

As understood in the art, the piston 16 travels a linear path within the bore 14 parallel to the axis 14A of the bore 14 between a top-dead-center (TDC) position and a bottom-dead-center (BDC) position, the latter of which is depicted in FIG. 1. As will become apparent from the following discussion, the device 10 lacks a conventional crankshaft to which pistons are conventionally coupled via connecting rods. As such, the BDC position of the piston 16 as seen in FIG. 1 may be described as its most retracted position within the bore 14, whereas the TDC position of the piston 16 (not shown in FIG. 1) may be described as its position farthest from the BDC position shown in FIG. 1, i.e., when the piston 16 is at its position closest to the top of the bore 14.

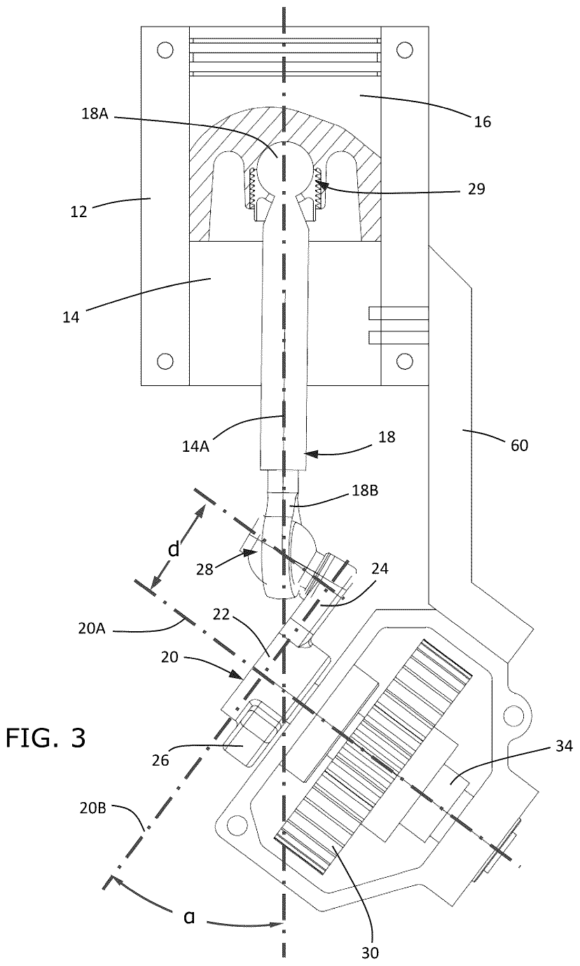

The device 10 is further shown in FIG. 1 as having a connecting rod 18 that is pivotably coupled to the piston 16 at a first end 18A of the rod 18. As will become apparent, a pivotal coupling between the piston 16 and connecting rod 18 must be capable of allowing three-dimensional motion of the rod 18 relative to the piston 16. A nonlimiting example of such a coupling is a ball-and-socket arrangement, such as depicted in FIG. 3. The connecting rod 18 protrudes from the bore 14 such that a second end 18B of the rod 18 is disposed outside of the bore 14. The second end 18B of the rod 18 is pivotably connected to a crank 20 by a coupling 28 that allows three-dimensional motion of the rod 18 relative to the crank 20. The crank 20 has an axis 20A of rotation and is adapted to rotate in a plane 20B that is disposed at an inclination angle α relative to the axis 14A of the cylinder bore 14. The crank 20 has a central hub 22 through which the axis 20A passes and an arm 24 that radially extends from the hub 22 in relation to the axis 20A. The coupling 28 is shown as mounted on the arm 24 at a location spaced a radial distance “d” from the axis 20A of the crank 20. As represented in FIG. 1, the coupling 28 is shown as mounted at or near a distal end of the arm 24. The crank 20 is adapted to be capable of rotating about its axis 20A at high rotational speeds in response to the reciprocation of the piston 16 within the bore 14, and for this reason a counterweight 26 is preferably disposed on the hub 22 opposite the arm 24 so as to dynamically balance the crank 20.

A crank gear 30 is arranged coaxially with the crank 20 and is coupled to the crank 20 via a shaft 34 so as to rotate therewith. If additional sets of cylinder bores 14, pistons 16, connecting rods 18, and cranks 20 are utilized by the device 10, the crank gear 30 is meshed with a crank gear associated with an adjacent crank. Ultimately, regardless of the arrangement, the rotation of the crank gear 30 is transferred to the output shaft 50, such as the result of the crank gear 30 being a bevel gear that is meshed with a second bevel gear 36 associated with the output shaft 50.

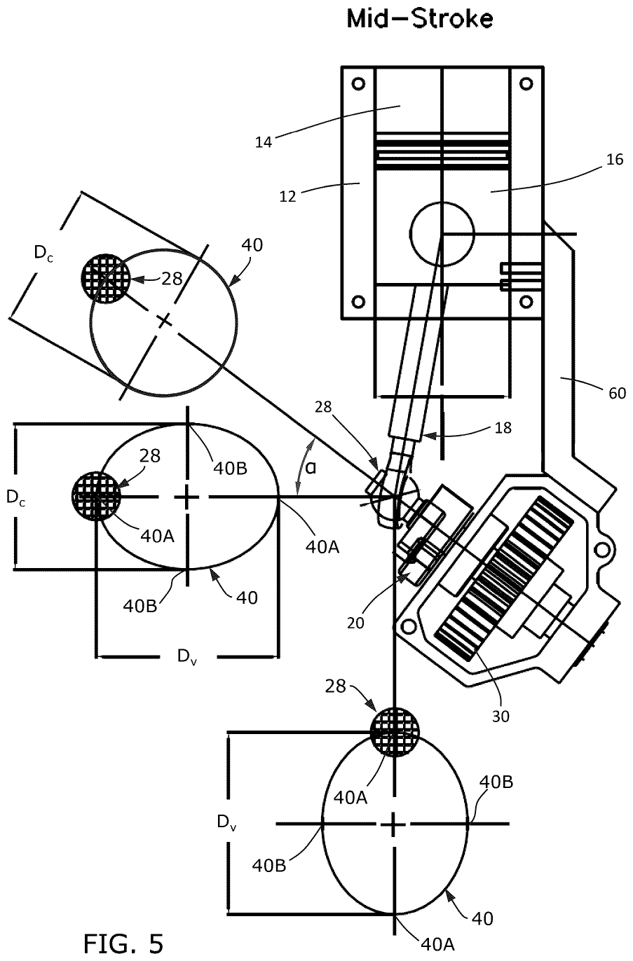

As previously noted, the crank 20 is adapted to rotate about its axis 20A in a plane 20B that is disposed at the inclination angle α relative to the axis 14A of the cylinder bore 14. The inclination angle α provides an important control parameter for the operation of the reciprocating mechanical device 10, in that it causes the second end 18B of the connecting rod 18 (and therefore also the coupling 28) to follow a rotational path 40 (such as portrayed in FIGS. 5, 6A, and 7) that has an elliptical shape relative to the axis 14A of the cylinder bore 14, which in turn causes the connecting rod 18 to have a three-dimensional motion. In order for the crank 20 to cause the second end 18B of the connecting rod 18 to follow an elliptical rotational path and the connecting rod 18 to have a three-dimensional motion, the inclination angle α must be greater than zero degrees. For the particular arrangement shown in FIG. 1, the inclination angle α is preferably up to but does not exceed forty-five degrees. In practice, it is believed that inclination angles α of greater than 10 degrees and less than 45 degrees are particularly suitable for obtaining acceptable though not necessarily optimal performance improvements. (It is noted that inclination angles of greater than 45 degrees invert the axis of the rotational path 40.) Numerical predictions have indicated that an inclination angle α of about 37 degrees is preferred for obtaining optimal power and efficiency of the device 10.

Another nonlimiting embodiment of the reciprocating mechanical device 10 is represented in FIGS. 2A through 2D. The reciprocating mechanical device 10 is represented as having what may be referred to as a multi-cylinder configuration due to there being three sets of cylinder bores 14 and pistons 16. In the nonlimiting example shown in FIGS. 2A through 2D, the coupling 28 between the connecting rod 18 and crank 20 is represented as a spherical joint or claw comprising a bearing race mounted at the second end 18B of the rod 18 and surrounding a ball mounted on the arm 24 of the crank 20.

The representation of the device 10 in FIGS. 2A through 2D further includes a crank gear 30 arranged coaxial with each crank 20 associated with each piston 16. The crank gears 30 are each meshed with another crank gear 30 associated with an adjacent crank 20, such that adjacent crank gears 30 rotate in opposite directions. In the arrangement of FIGS. 2A through 2D, the rotations of the cranks 20 are transmitted through their crank gears 30 to the output shaft 50 as the result of the last crank gear 30 in the series being meshed with a driven gear 32 that is coupled for rotation with a bevel gear 38 that is meshed with the bevel gear 36 associated with the output shaft 50.

FIGS. 2A through 2D further represent the reciprocating mechanical device 10 as equipped with an overhead cam shaft 52 by which intake and exhaust valves (not shown) associated with the cylinder bores 14 are able to operate in a suitable manner to draw fuel mixtures into the bores 14 and exhaust combustion gas from the bores 14, such as is required during the operation of conventional internal combustion engines. As evident from FIGS. 2A and 2B, the device 10 can be equipped with a gear 54 mounted to the cam shaft 52 and arranged to be driven by a gear 56 mounted to the output shaft 50, such as through a belt or chain as is commonly done in conventional internal combustion engines.

In view of the above, both embodiments of the device 10 described above operate with at least one crank 20 adapted to rotate about its axis 20A in a plane 20B that is disposed at an inclination angle α relative to the axis 14A of a cylinder bore 14 associated therewith, such that the connecting rod 18 has a three-dimensional motion and the coupling 28 (as well as the second end 18B of the connecting rod 18 associated therewith) follows an elliptical rotational path 40 (sometimes referred to herein as an elliptical path 40) relative to the axis 14A of the cylinder bore 14. FIG. 3 represents what is referred to herein as a single cylinder unit comprising a cylinder bore 14, piston 16, connecting rod 18, coupling 28, crank 20, and crank gear 30 essentially as described previously. FIG. 3 further represents a nonlimiting example of the aforementioned pivotal coupling 29 between the piston 16 and connecting rod 18 that enables three-dimensional motion of the rod 18 relative to the piston 16. In this particular example, the coupling 29 is represented as a ball-and-socket arrangement or a swivel ball-and-socket arrangement, with a ball defined at the first end 18A of the connecting arm 18 and a socket formed in the piston 16. A bracket 60 is represented as rigidly mounting the crank 20, crank gear 30, and shaft 34 to the cylinder block 12.

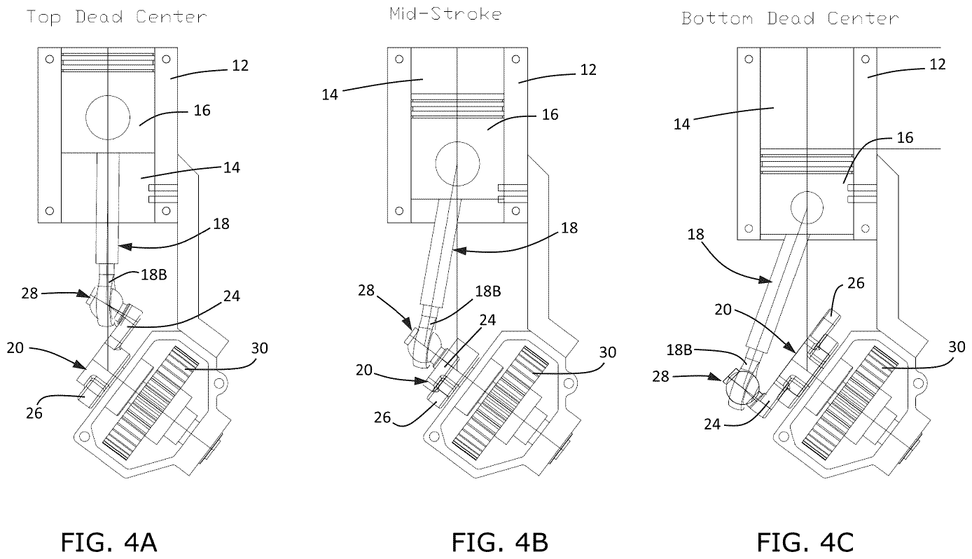

FIG. 3 represents the piston 16 in its TDC position, i.e., with the coupling 28 at its closest location to the cylinder bore 14. This arrangement is also shown in FIG. 4A alongside, for comparison, a mid-stroke position of the piston 16 shown in FIG. 4B and a BDC position of the piston 16 shown in FIG. 4C. In the particular embodiment shown in FIGS. 4A, 4B, and 4C, the connecting rod 18 is depicted as being approximately coaxial with the axis 14A of the cylinder bore 14 (and therefore also with the axis of the piston 14) when the piston 16 is at its TDC position shown in FIG. 4A. Due to the inclination angle α of the crank 20, the connecting rod 18 is at an increasingly greater angle relative to the axis 14A of the bore 14 as the distance of the piston 16 from its TDC position shown in FIG. 4A increases, with its maximum angle relative to the axis 14A of the bore 14 occurring at the BDC position of the piston 16 of FIG. 4C. Such an arrangement is believed to be optimal for power and efficiency of the device 10, though it is foreseeable that the crank 20 could be arranged so that the connecting rod 18 is approximately coaxial with the axis 14A of the cylinder bore 14 when the piston 16 is at its BDC position shown in FIG. 4C or an intermediate position between the TDC and BDC positions (such as the mid-stroke position shown in FIG. 4B).

FIG. 5 provides another representation of the cylinder unit showing the piston 16 in the mid-stroke position of FIG. 4B. FIG. 5 further contains three representations of the elliptical rotational path 40 of the coupling 28 as observed from three different directional views relative to the crank 20. The upper left depiction of the path 40 is taken coaxial with the axis 20A of the crank 20. Because the coupling 28 is at a fixed distance d from the axis 20A, the path 40 followed by the coupling 28 appears to be circular in this view. The left side and bottom depictions of the path 40 are taken, respectively, perpendicular and parallel to the axis 14A of the bore 14. Because the crank 20 is at the inclination angle α relative to the axis 14A of a bore 14, the path 40 followed by the coupling 28 can be seen in these views to have an elliptical shape.

As known in the art, an ellipse has an eccentricity of greater than zero, which refers to the ratio of the diameter of the ellipse between its vertices and the diameter of the ellipse of the ellipse between its co-vertices, as the result of an ellipse having two foci that do not coincide with each other, as is the case required for a circle. As evident from FIG. 5, the elliptical rotational path 40 of the coupling 28 has first and second vertices 40A and first and second co-vertices 40B, and the vertices 40A coincide with the mid-stroke positions of the piston 16. The co-vertices 40B coincide with the top-dead-center (TDC) position and the bottom-dead-center (BDC) position of the piston 16. In the situation where the inclination angle α of the crank 20 is about 37 degrees (secant of 37 degrees=1.25), the co-vertex: vertex diametrical ratio (D_{c}: Dᵥ) is about 1 to 1.25. Computational investigations have indicated that a D_{c}: Dᵥ ratio of 1:1.25 is capable of optimizing piston and applied torque lever forces at the crank 20 for engine performance and optimization. More particularly, a 1:1.25 D_{c}: Dᵥ ratio has been calculated to produce a 125% increase in power output in a reciprocating mechanical device without changing its engine bore and stroke displacement, with the result of a saving of about 25% in fuel consumption.

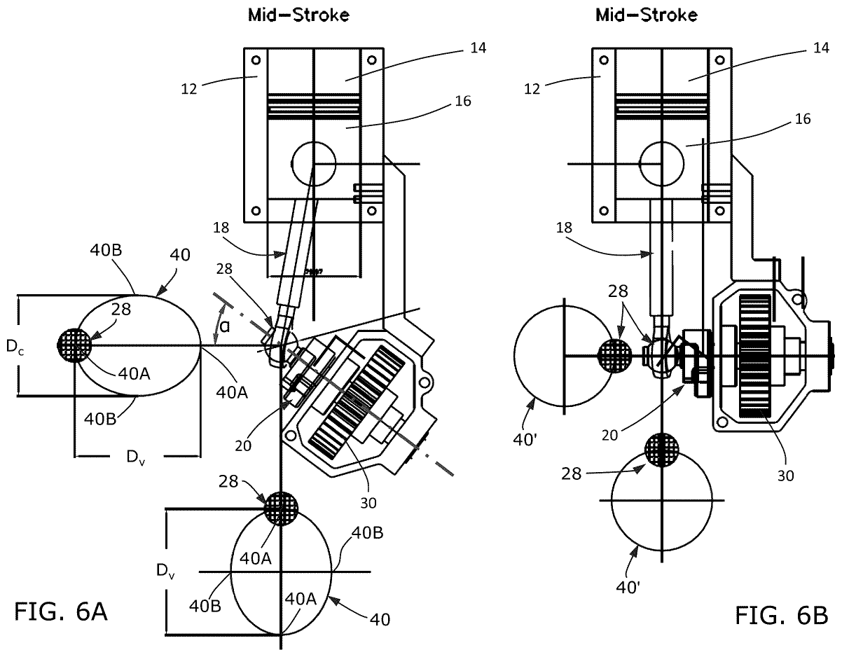

The elliptical rotational path 40 of the connecting rod 18 at the coupling 28, resulting from the three-dimensional motion of the connecting rod 18, differs from the traditional two-dimensional motion of connecting rods that is dictated by pistons and crankshafts in conventional motors, pumps, and compressors to more effectively harnesses the displaced movement of a reciprocating piston. This difference is also illustrated in FIGS. 6A and 6B, in which FIG. 6A replicates FIG. 5 minus the upper left depiction of the path 40 taken coaxial with the axis 20A of the crank 20. As in FIG. 5, FIG. 6A contains depictions of the path 40 taken, respectively, perpendicular and parallel to the axis 14A of the bore 14, and evidence the elliptical shape of the path 40 of the coupling 28 due to the crank 20 being disposed at the inclination angle α of greater than 0 degrees (in this example, about 37 degrees) relative to the axis 14A of the cylinder bore 14. In contrast, FIG. 6B contains corresponding depictions of a circular path 40′ of the coupling 28 resulting from the crank 20 being disposed at an inclination angle α of 0 (zero) degrees relative to the axis 14A of the bore 14. The depictions of the path 40′ of the coupling 28 are taken from both perpendicular and parallel directions to the axis 14A of the bore 14, confirming that the path 40′ has a circular shape.

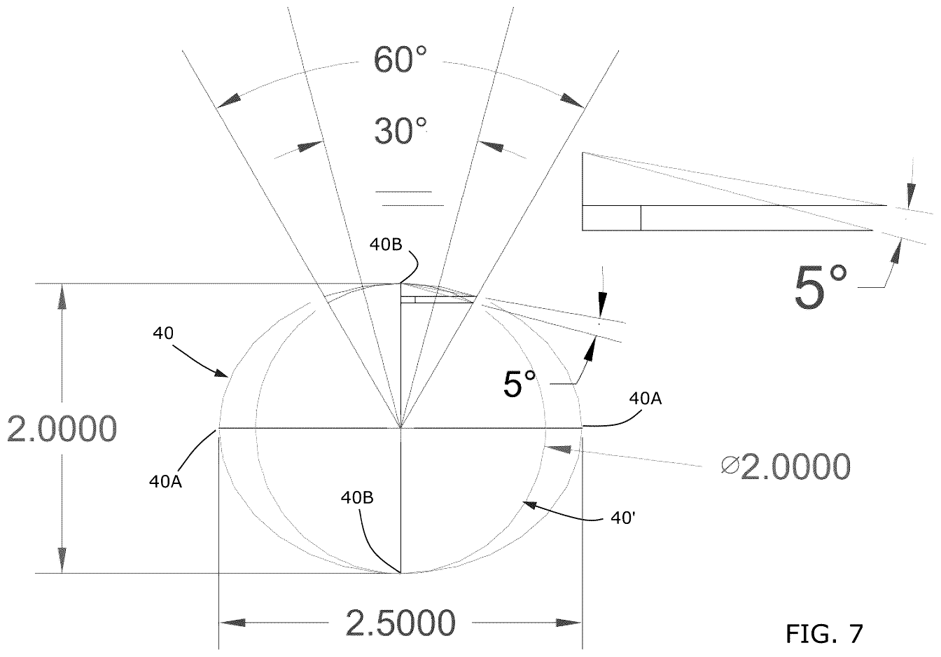

FIG. 7 provides additional details of a representative elliptical path 40 of the coupling 28 corresponding to FIG. 6A in comparison to a representative circular path 40′ corresponding to FIG. 6B. FIG. 7 diagrammatically represents the circular path 40′ as having a diameter of 2.000 inches (about 5 cm) and the elliptical path 40 as having a width at its vertices (Dᵥ) of 2.5000 inches (about 6.35 cm) and a width at its co-vertices (D_{c}) of 2.000 inches (about 5 cm), yielding a diametrical ratio (D_{c}: Dᵥ) is about 1 to 1.25. FIG. 7 represents that the elliptical path 40 achieves an increased “dwell” time, being, for example the annular rotational time at TDC (60 degrees30 degrees of rotation), as compared to the circular path 40′ (30 degrees of rotation), such that the elliptical path 40 is able to promote more complete combustion during the combustion cycle than possible with the circular path 40′. FIG. 7 further indicates that the dwell at TDC associated with the elliptical path 40 corresponds to 12 degrees of elliptical rotation of the crank 20 in FIG. 6A, as compared to 5 degrees of circular rotation of the crank 20 when oriented as shown in FIG. 6B.

In view of the foregoing, unlike traditional internal combustion engines that operate with a crankshaft to convert linear piston motion into rotational motion of the crankshaft entirely within a two-dimensional orbit coinciding with the axis of the piston, the reciprocating mechanical devices 10 as described above employ a crank 20 and coupling 28 that is able to capture motion within a three-dimensional orbit resulting from the crank 20 being disposed at an angle to the axis of the piston 16. By eliminating a conventional crankshaft and harnessing a three-dimensional orbital movement, the reciprocating mechanical devices 10 can utilize gearing systems (e.g., gears 30, 32, 36, and 38) to regenerate rotary motion that can be outputted to a shaft 50. The inclination angle α of the crank 20 can be utilized to provide an important control parameter for the operation of the reciprocating mechanical devices 10, enabling achievements such as increased efficiency, power output, and reduced environmental impact.

By utilizing an elliptical rotational path 40 at the second end 18B of the connecting rod 18, when utilized as engines the devices 10 are capable of effectively harnessing vector forces by changing the lever arm force and distance (d) required to generate torque through the crank arm 24. Computational investigations have indicated that an elliptical path 40 with a D_{c}: Dᵥ ratio of 1:1.25 is capable of generating 25% more torque than that of a conventional engine of similar bore size. Stated another way, a reciprocating mechanical device 10 as described herein and having a displacement of 1600 cc may be capable of generating the same power output as a conventional engine having a displacement of 2000 cc engine purely by changing the pathway of the crankshaft.

In addition to increased torque, fuel economy can be improved with a reciprocating mechanical device 10 as described herein without altering the displacement. Utilizing the elliptical rotational path 40 with a D_{c}: Dᵥ ratio of 1:1.25, significantly improved fuel economy can be achieved as a result of the piston dwell time at TDC being increased by 12% (12 degrees versus 5 degrees of rotation) compared to a conventional engine. This extended dwell time results in more efficient fuel combustion, reducing the hydrocarbon and carbon monoxide emission and increasing the burn rate during the combustion cycle. Such a capability may achieve a 25% improvement in gas mileage with the same fuel quantity as a vehicle (e.g., aircraft, automobile, boat, etc.) equipped with a conventional internal combustion engine, without altering the engine's displacement size.

Engine performance is significantly enhanced with a reciprocating mechanical device 10 that utilizes an elliptical rotational path 40 as described herein. The radius of curvature of an ellipse offers a greater rate of acceleration reciprocating motion. When utilized as an engine, the device 10 is capable of performing faster with increased torque output, such that the device 10 is more responsive than a conventional engine. The push-pull effect of a connecting rod 18 having three-dimensional motion as a result of the elliptical rotational path 40 can be synchronized with compression and combustion cycles of the engine to minimize inefficiencies between engine cycles. A phased combustion cycle partially transfers the pushing forces required during the compression cycle. This change in cycle timing, proportional to the elliptical shape of the rotational path 40, results in a more efficient internal combustion engine cycle, ensuring smoother operation as vector forces are balanced in multi-cylinder engines.

Reciprocating mechanical devices 10 as described herein replace the crankshaft of a conventional engine with the crank 20 and coupling 28 to capture the three-dimensional motion of the connecting rod 18 at its second end 18B. The coupling 28 oscillates freely along the elliptical rotational path 40 within a defined orbit and translates the elliptical rotational path 40 into a concentric rotation motion at the crank 20, allowing the devices 10 to output a conventional rotary motion as its power output. As such, an engine manufacturer is able to integrate reciprocating mechanical devices 10 as described herein into existing production lines with only minor adjustments to assembly instructions, following current manufacturing protocols.

As previously noted above, though the foregoing detailed description describes certain aspects of one or more particular embodiments of the invention, alternatives could be adopted by one skilled in the art. For example, the reciprocating mechanical devices 10 and their components could differ in appearance and construction from the embodiments described herein and shown in the drawings, functions of certain components of the reciprocating mechanical devices 10 could be performed by components of different construction but capable of a similar (though not necessarily equivalent) function, and various materials could be used in the fabrication of the reciprocating mechanical device and/or its components. As such, and again as was previously noted, it should be understood that the invention is not necessarily limited to any particular embodiment described herein or illustrated in the drawings.

1. A reciprocating mechanical device comprising:
at least a first cylinder bore having an axis;
a first piston disposed in the first cylinder bore and adapted for reciprocation therein between a top-dead-center position and a bottom-dead-center position of the first piston;
a first connecting rod having a first end pivotably coupled with the first piston, the first connecting rod protruding from the first cylinder bore and having a second end disposed outside of the first cylinder bore; and
a first crank having an axis about which the first crank is adapted to rotate in a plane disposed at an inclination angle to the axis of the first cylinder bore, the inclination angle being greater than 0 degrees and up to 45 degrees, the first crank having a hub, an arm radially extending from the hub, and a coupling mounted on the arm a radial distance from the axis, the coupling pivotably coupling the arm to the second end of the first connecting rod;
wherein the inclination angle of the first crank causes the first connecting rod to have a three-dimensional motion and the second end of the first connecting rod to follow an elliptical rotational path relative to the axis of the first cylinder bore.

2. The reciprocating mechanical device of claim 1, further comprising a gear system comprising:
a first crank gear arranged coaxial with the first crank and coupled to the first crank to rotate therewith; and
a driven gear meshed with the first crank gear.

3. The reciprocating mechanical device of claim 2, further comprising an output shaft driven by the driven gear.

4. The reciprocating mechanical device of claim 1, wherein the inclination angle is greater than 10 degrees and less than 45 degrees.

5. The reciprocating mechanical device of claim 1, wherein the inclination angle is about degrees.

6. The reciprocating mechanical device of claim 1, wherein the elliptical rotational path of the first connecting rod has first and second co-vertices coinciding with, respectively, the top-dead-center position and the bottom-dead-center position of the first piston.

7. The reciprocating mechanical device of claim 6, wherein the first co-vertex of the elliptical rotational path provides a dwell time at the top-dead-center position.

8. The reciprocating mechanical device of claim 6, wherein the elliptical rotational path has a co-vertex: vertex diametrical ratio (D_{c}: Dᵥ) of 1 to 1.25.

9. The reciprocating mechanical device of claim 1, wherein the reciprocating mechanical device is a motor.

10. The reciprocating mechanical device of claim 9, wherein the motor is an internal combustion engine.

11. The reciprocating mechanical device of claim 1, wherein the reciprocating mechanical device is a pump or compressor.

12. The reciprocating mechanical device of claim 1, wherein the reciprocating mechanical device is a generator.

13. The reciprocating mechanical device of claim 1, further comprising:
a second cylinder bore having an axis;
a second piston disposed in the second cylinder bore and adapted for reciprocation therein between a top-dead-center position and a bottom-dead-center position of the second piston;
a second connecting rod having a first end pivotably coupled with the second piston, the second connecting rod protruding from the second cylinder bore and having a second end disposed outside of the second cylinder bore; and
a second crank having an axis about which the second crank is adapted to rotate in a plane disposed at an inclination angle to the axis of the second cylinder bore, the inclination angle being greater than 0 degrees and up to 45 degrees, the second crank having a hub, an arm radially extending from the hub of the second crank, and a coupling mounted on the arm of the second crank a radial distance from the axis, the coupling of the second crank pivotably coupling the arm the second crank to the second end of the second connecting rod.

14. A reciprocating mechanical device comprising:
at least first and second cylinder bores disposed within a cylinder block, each of the first and second cylinder bores having an axis;
first and second pistons disposed in, respectively, the first and second cylinder bores and adapted for reciprocation therein between a top-dead-center position and a bottom-dead-center position of each of the first and second pistons;
first and second connecting rods each having a first end pivotably coupled with, respectively, the first and second pistons, the first connecting rod protruding from the first cylinder bore and having a second end disposed outside of the first cylinder bore, the second connecting rod protruding from the second cylinder bore and having a second end disposed outside of the second cylinder bore;
first and second cranks each having an axis, the first crank being adapted to rotate in a first plane disposed at a first inclination angle to the axis of the first cylinder bore, the second crank being adapted to rotate in a second plane disposed at a second inclination angle to the axis of the second cylinder bore, each of the first and second inclination angles being greater than 10 degrees and less than 45 degrees, the first crank having a first hub, a first arm radially extending from the first hub, and a first spherical joint mounted on the first arm a first radial distance from the axis of the first crank, the second crank having a second hub, a second arm radially extending from the second hub, and a second spherical joint mounted on the second arm a second radial distance from the axis of the second crank, the first spherical joint pivotably coupling the first arm to the second end of the first connecting rod, the second spherical joint pivotably coupling the second arm to the second end of the second connecting rod;
first and second crank gears arranged coaxial with, respectively, the first and second cranks and coupled to, respectively, the first and second cranks to rotate therewith, the first and second crank gears being meshed together; and
a driven gear meshed with the second crank gear;
wherein the first inclination angle of the first crank causes the first connecting rod to have a three-dimensional motion and the second end of the first connecting rod to follow a first elliptical rotational path, and the first elliptical rotational path has first and second co-vertices coinciding with, respectively, the top-dead-center position and the bottom-dead-center position of the first piston; and
wherein the second inclination angle of the second crank causes the second connecting rod to have a three-dimensional motion and the second end of the second connecting rod to follow a second elliptical rotational path relative to the axis of the second cylinder bore, and the second elliptical rotational path has first and second co-vertices coinciding with, respectively, the top-dead-center position and the bottom-dead-center position of the second piston.

15. The reciprocating mechanical device of claim 14, wherein each of the first and second inclination angles is 37 degrees.

16. The reciprocating mechanical device of claim 14, wherein the first co-vertices of the first and second elliptical rotational paths provide dwell times at the top-dead-center position of each of the first and second pistons.

17. The reciprocating mechanical device of claim 14, wherein each of the first and second elliptical rotational paths has a co-vertex: vertex diametrical ratio (D_{c}: Dᵥ) of 1 to 1.25.

18. The reciprocating mechanical device of claim 14, wherein the reciprocating mechanical device is a motor.

19. The reciprocating mechanical device of claim 18, wherein the motor is an internal combustion engine.

20. The reciprocating mechanical device of claim 14, wherein the reciprocating mechanical device is a pump or compressor.

21. The reciprocating mechanical device of claim 14, wherein the reciprocating mechanical device is a generator.

22. A method of operating a reciprocating mechanical device that comprises at least a first cylinder bore having an axis, a first piston disposed in the first cylinder bore and adapted for reciprocation therein between a top-dead-center position and a bottom-dead-center position of the first piston, and a first connecting rod having a first end pivotably coupled with the first piston, the first connecting rod protruding from the first cylinder bore and having a second end that is disposed outside of the first cylinder bore and has a connection to a crank, the method comprising:
operating the reciprocating mechanical device so that the connecting rod has a three-dimensional motion and the connection between the connecting rod and the crank follows on an elliptical rotational path relative to the axis of the first cylinder bore.
